(19) United States
(12) Patent Application Publication
(10) Pub. No.: US 2026/0141428 A1
(43) Pub. Date: May 21, 2026

(54) ARTIFICIAL INTELLIGENCE TECHNOLOGIES FOR ESTIMATING COSTS IN BUILDING CONSTRUCTION

(71) Applicant: MITEK HOLDINGS, INC., Wilmington, DE (US)

(72) Inventor: Siddharth Goyal, Cumming, GA (US)

(21) Appl. No.: 19/393,768

(22) Filed: Nov. 19, 2025

Related U.S. Application Data
(60) Provisional application No. 63/722,557, filed on Nov. 19, 2024.

(51) Int. Cl. G06Q 30/0283; G06Q 10/0631; G06Q 50/08

(52) U.S. Cl. CPC G06Q 30/0283; G06Q 10/06313; G06Q 50/08

(57) ABSTRACT

Technologies for estimating costs in building construction with artificial intelligence include a system configured to obtain project planning data indicative of a planned construction of a building, perform one or more preprocessing operations on the obtained project planning data to prepare a feature vector usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data, produce, with each determined subset of artificial intelligence models associated with each identified class and as a function of the obtained project planning data and the feature vector, estimation data indicative of an estimated cost associated with construction of the building, and present the estimation data.

### CROSS-REFERENCE TO RELATED APPLICATION

The present application claims the benefit of U.S. Provisional Patent Application No. 63/722,557, filed Nov. 19, 2024, the disclosure of which is incorporated herein by reference.

### BACKGROUND

The construction of a sophisticated building may involve a combination of labor, materials, and components from multiple sources over an extended period of time. The availability of such items may vary as a function of the location of the construction site, transportation costs, and the time period in which the construction is to take place. Furthermore, available information regarding the building itself, such as architectural drawings, may be incomplete. In view of these challenges, planning for the construction of a building may be a nearly intractable problem for both an organization overseeing the construction of the building and for any organizations contributing to the construction of the building (e.g., component manufacturers, such as manufacturers of trusses to be used in the building). Accordingly, delays in the construction of a building may arise due to unforeseen costs or other complexities.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for estimating costs in building construction with artificial intelligence;

FIG. 2 is a diagram of at least one embodiment of a compute device of the system of FIG. 1;

FIGS. 3-6 are flowcharts of at least one embodiment of a method for estimating costs in building construction with artificial intelligence that may be performed by the system of FIG. 1; and

FIG. 7 is a diagram of operations that may be performed by the system of FIG. 1 for preprocessing data, performing feature extraction, and utilizing artificial intelligence models to estimate costs in building construction.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

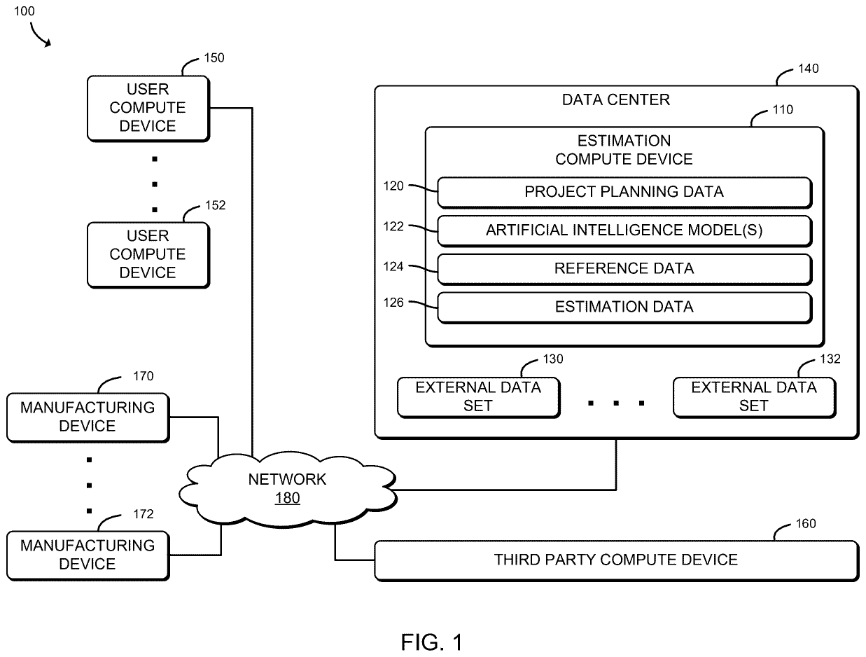

Referring now to FIG. 1, a system 100 for estimating building construction costs with artificial intelligence includes, in the illustrative embodiment, an estimation compute device 110 communicatively connected to user compute devices 150, 152. The estimation compute device 110, in the illustrative embodiment, is also communicatively connected to one or more third party compute devices 160. In at least some embodiments, the estimation compute device 110 may be located in a data center 140 (e.g., a cloud data center) which may be embodied as a set of networked computer servers (each a compute device) and associated infrastructure (e.g., energy distribution devices, thermal management devices, networking devices) to execute software (e.g., one or more software applications) and manage data. In operation, the estimation compute device 110 obtains project planning data 120, which may be embodied as any data indicative of a planned construction of a building (e.g., geographic location of the building, construction completion date, architectural drawings representing one or more views of the planned building, etc.). Further, in operation, the estimation compute device 110 utilizes one or more artificial intelligence models 122 to predict costs associated with the construction of the building, based at least in part on the obtained project planning data 120. In doing so and as described in more detail herein, the estimation compute device 110 may perform preprocessing operations on the obtained project planning data to produce a feature vector (e.g., a set) of features (e.g., each a measured property or characteristic of an object or phenomenon that may be expressed in a numerical or categorical form) for use by the artificial intelligence models 122. Further, in doing so, the estimation compute device 110 may perform image segmentation, object recognition, optical character recognition, natural language processing, and/or other operations to extract and/or infer data from the available project planning data 120.

One or more of the artificial intelligence models 122 may be a machine learning model. It should be appreciated that a machine learning model refers to an algorithm or collection of algorithms that takes structured and/or unstructured data inputs and generates a prediction or result. The prediction is typically a value or set of values. A machine learning model may itself include one or more component models that interact to yield a result. As used herein, a machine learning model represents both machine learning processing and the model that is created through successive executions of the model. Typically, a model is executed successively during a training phase and after it has been successfully trained, is used operationally to evaluate new data and make predictions. The training phase may be executed thousands of times in order to obtain an acceptable model capable of producing accurate predictions. Further, the model may discover thousands or even tens of thousands of features. Many of these features may be quite different than the features provided as input data. Thus, the model is not known in advance and the calculations cannot be made through mental effort alone. In some embodiments, the machine learning model/algorithm may utilize one or more neural network algorithms, regression algorithms, instance-based algorithms, regularization algorithms, decision tree algorithms, Bayesian algorithms, clustering algorithms, association rule learning algorithms, deep learning algorithms, dimensionality reduction algorithms, and/or other suitable machine learning algorithms, techniques, and/or mechanisms. It should also be understood, that in some embodiments, the machine learning model may be embodied as a single machine learning model, whereas in other embodiments, the machine learning model may be embodied as a set (ensemble) of machine learning models realizing as a whole the intended function.

In some embodiments, a machine learning model utilized by the system 100 may be a gradient boosted model, which may be embodied as an ensemble of weak learners (e.g., decision trees) that, together, form a more accurate predictive model. The gradient boosted model may be trained with an ensemble metaheuristic to produce the ensemble of weak learners. In other embodiments, the machine learning model may have a different architecture, such as a neural network. A neural network, also referred to herein as an artificial neural network, is a set of connected units or nodes that model the neurons in a brain and that are connected via edges, which model synapses in the brain. Each neuron is configured to receive corresponding signals from connected neurons, then process those signals and produce a resulting signal to other connected neurons. The resulting signal is produced based on an activation function, which is a function that determines an output of a node based on the individual inputs and weights associated with those inputs. In other words, each neuron of an intermediate or last layer may receive an input signal, e.g., a weighted sum of output signals from other neurons, and may process the input signal using a linear or nonlinear function (e.g., an activation function). The activation function may be, for example, a rectified linear unit activation function, a gaussian error linear unit activation function, or a logistic sigmoid function. It should be appreciated that one or more processors (e.g., CPUs or GPUs) or other hardware devices may be dedicated to executing the neural network or other machine learning model in some embodiments. In some embodiments, the system 100 may utilize a recurrent neural network (RNN), which is a specialized type of artificial neural network designed for sequential data processing and that utilizes a recurrent unit that maintains a hidden state that is updated for each of multiple time steps based on a present input and a previous hidden state. A feedback loop may enable the RNN to learn from previous inputs and incorporate that information into the current processing.

Further, for natural language processing operations, the system 100 may use a language model, such as a large language model (LLM). An LLM is a machine learning model designed for natural language processing operations and is trained using self-supervised learning on a relatively large amount of text. The LLM may, in some embodiments, be a generative pretrained transformer (GPT). In a transformer architecture, text is converted into a vector structure through a word embedding table, and in each of multiple layers of the architecture, the transformer contextualizes the token within the scope of a context window with other tokens through a parallel multi-head attention mechanism. Through the architecture, a signal for a key (e.g., significant) token may be amplified and the signal for a less significant token may be de-emphasized. A GPT is a type of generative artificial intelligence framework based on a transformer deep learning architecture that is pre-trained on a relatively large data set of unlabeled text to produce human-like outputs.

The system 100 may perform image segmentation operations, as described herein, using one or more artificial intelligence models 122. Machine learning approaches to image segmentation frame the task as a per-pixel classification problem, where a model learns to predict a label for every single pixel in an image after training on a large dataset. Unlike traditional methods that rely on hand-engineered features like intensity thresholds or edge detection heuristics, a machine learning model such as a deep neural network may automatically extract hierarchical features from the data based on recognized patterns and spatial relationships within the pixels that correspond to specific objects or regions. The model 122 is thus able to generalize and accurately segment new, unseen images with greater precision and robustness to variations, such as changes in orientation or scale.

In some embodiments, the system 100 may utilize one or more fully convolutional networks (FCNs) or U-Nets. Such networks may employ an encoder-decoder structure. The encoder part acts as a feature extractor, down sampling the image to develop an internal representation of a high-level context of the image and capture semantic information. More specifically, the encoder part of the network, in at least some embodiments, passes the input image through a series of convolutional and pooling layers, which progressively reduce the spatial dimensions while extracting higher-level, more abstract features, such as edges, shapes, and textures. This process effectively compresses the image data into a feature map, discarding non-essential information and capturing the contextual information of the scene.

The decoder then operates to up sample the information, reconstructing the image while performing a pixel-wise classification to create a detailed segmentation mask. The segmentation map provides pixel-wise classification, where each pixel is assigned a label corresponding to its semantic class. To increase the likelihood of preserving the precise localization of object boundaries that may otherwise be lost during the down sampling (pooling) stage, a model 122 may utilize connections (skip connections) that link feature maps from early encoder layers to later decoder layers, preserving fine-grained spatial details and resulting in more accurate and detailed segmentation masks.

The models 122 may include one or more artificial intelligence models for performing optical character recognition. Such a model 122 may include, for example, one or more convolutional neural networks (CNNs). Unlike simple template matching, which may fail to recognize text due to slight changes in font, CNNs break down characters into fundamental components such as lines, curves, and intersections. The network learns to identify these features robustly, regardless of minor variations in style or size. The resulting feature extraction, combined with a classification layer, allows the OCR system to accurately identify characters with higher accuracy than traditional methods, making such models 122 highly effective for diverse and inconsistent inputs.

A model 122 that performs optical character recognition may be supplemented by natural language processing (NLP) model, such as in a post-processing stage. Doing so may provide error correction based on the context of a given recognized character. That is, after the model 122 makes initial character predictions, an NLP model may apply linguistic rules, dictionaries, and grammatical context to refine the output. For example, if a character is ambiguous and the model 122 has low confidence in its classification, an NLP model may cross-reference the sequence of characters and suggest the most probable word based on the language model. As such, the contextual analysis may significantly boost the final accuracy of the OCR operations, increasing the likelihood that the recognized text is grammatically and contextually correct.

As described in more detail herein, the estimation compute device 110 may utilize a combination of artificial intelligence models 122 to produce subsets of estimation data 126 that ultimately form a combined estimate of the costs associated with the planned construction. In doing so, the estimation compute device 110 may select or weight output from multiple artificial intelligence models 122 based on an accuracy of each model in producing predictions compared to prior construction projects with known costs and having features (e.g., in a feature vector) determined be similar (e.g., based on a similarity score) to the presently planned construction. Furthermore, the estimation compute device 110 may utilize reference data 124 which may be embodied as any data associated with a context in which the building is to be constructed and that may influence costs associated with the construction, including data indicative of construction component costs (e.g., costs of trusses, which may vary as a function of a variety of factors, including length, material, and/or ply), macroeconomic variables (e.g., cost of living, inflation, labor rates, labor supply and demand) in the geographic location where the building is to be constructed, and/or other factors. The estimation compute device 110 may obtain the reference data 124 for a particular planned construction from (e.g., by querying) one or more external data sets 130, 132 and/or a third party compute device 160. The estimation compute device 110 may present the estimation data 126 to one or more user compute devices 150, 152 which may be operated by a user (e.g., a person associated with a project planning organization or a component manufacturer) for review. Similarly, in at least some embodiments, the estimation compute device 110 may perform corresponding operations to produce and present estimation data indicative an estimated cost associated with the construction and/or use of one or more specific construction components, or building components (e.g., one or more trusses such as roof trusses or floor trusses, or one or more wall panels, or one or more engineered wood products, or other building components that may be premanufactured).

In some embodiments, after a determination that estimation data satisfies applicable criteria, the system 100 may initiate production of one or more components of the building. In doing so, the system 100 may utilize one or more manufacturing devices 170, 172, which may include robots, saws, presses, conveyors, and/or other machines adapted to construct or assist in the construction of one or more parts of the building. In doing so, the manufacturing devices 170, 172 may perform operations such as cutting lumber, positioning pieces of cut lumber relative to each other, fastening pieces of cut lumber relative to each other with nails or other fastening elements, and/or other manufacturing operations. The resulting manufactured components may then be transported to a construction site for integration into the building.

While a relatively small number of devices 110, 150, 152, 160, 170, 172 are shown in FIG. 1 for simplicity and clarity, it should be understood that the number of devices, in practice, may range in the tens, hundreds, thousands, or more. Likewise, it should be understood that the devices 110, 150, 152, 160, 170, 172 may be distributed differently or perform different roles than the configuration shown in FIG. 1. Further, though shown as separate devices 110, 150, 152, 160, 170, 172 in some embodiments, the functionality of one or more of the devices 110, 150, 152, 160, 170, 172 may be combined into fewer devices and/or distributed across more devices than those shown in FIG. 1.

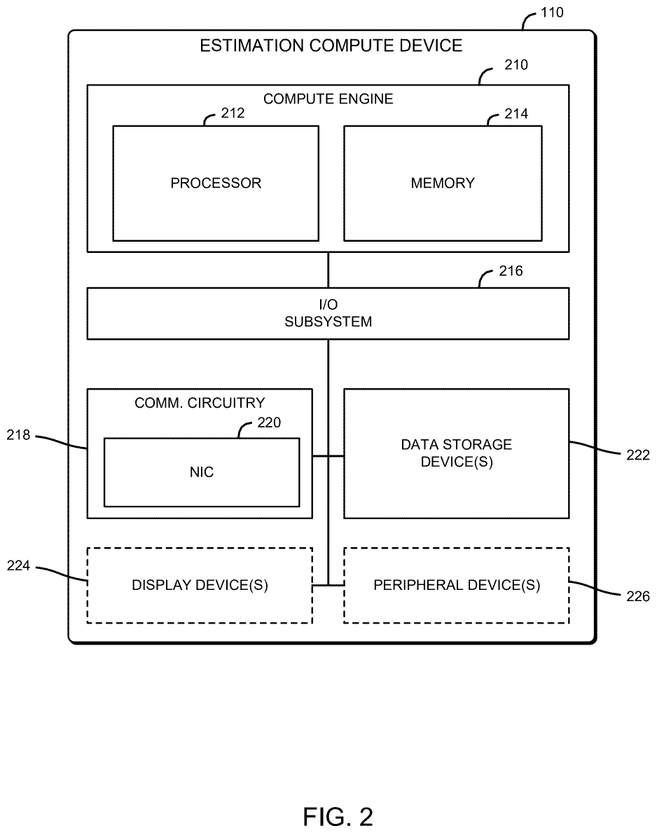

Referring now to FIG. 2, an illustrative embodiment of the estimation compute device 110, includes a compute engine 210, an input/output (I/O) subsystem 216, communication circuitry 218, and one or more data storage devices 222. In some embodiments, the estimation compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as at least one processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), one or more graphics processing units (GPUs), neural processing units (NPUs), and/or floating point units (FPUs), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the estimation compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as project planning data, reference data, estimation data, artificial intelligence models, applications, libraries, and drivers.

The compute engine 210 is communicatively coupled to other components of the estimation compute device 110 via the I/O subsystem 216, which may be embodied as circuitry and/or components to facilitate input/output operations with the compute engine 210 (e.g., with the processor 212 and the main memory 214) and other components of the estimation compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the estimation compute device 110, into the compute engine 210.

The communication circuitry 218 may be embodied as any communication circuit, device, or collection thereof, capable of enabling communications over a network between the estimation compute device 110 and another device (e.g., a device 110, 150, 152, 160, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the estimation compute device 110 to connect with another device (e.g., a device 150, 152, 160, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the estimation compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage devices. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the estimation compute device 110 are housed in a single unit. However, in other embodiments, the components may be in separate housings. The other devices 150, 152, 160, 170, 172 may include components similar to those of the estimation compute device 110 and/or other components (e.g., end effectors, motors, servos, saws, etc.). Further, the devices 110, 150, 152, 160, 170, 172 may include other components, sub-components, and devices commonly found in a computing device, which are not discussed above in reference to the estimation compute device 110 and not discussed herein for clarity of the description.

In the illustrative embodiment, the devices 110, 150, 152, 160, 170, 172 are in communication via a network 180, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

One or more of the devices 110, 150, 152, 160, 170, 172 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

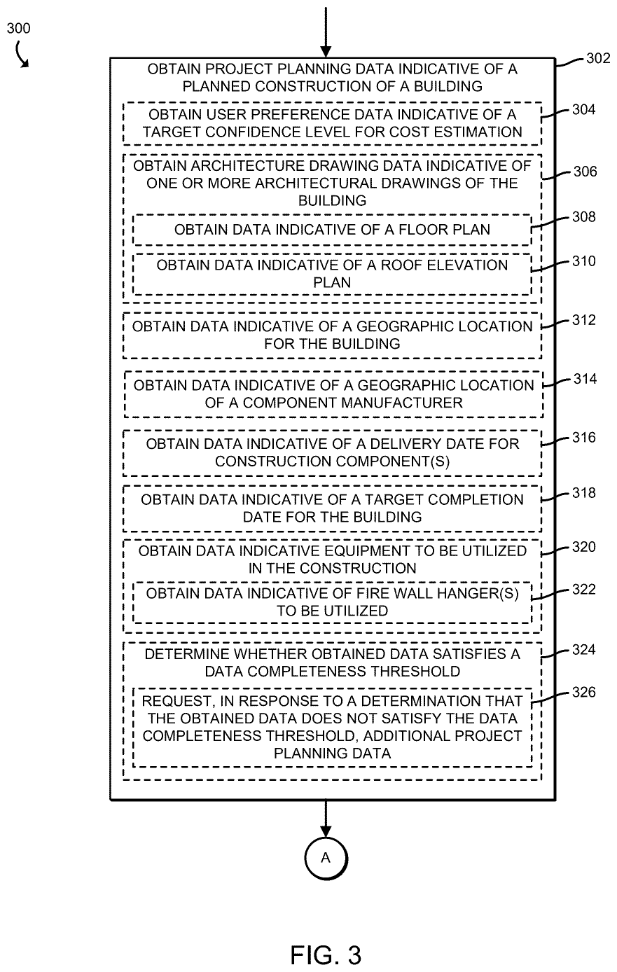

Referring now to FIG. 3, the system 100 (e.g., the estimation compute device 110) may perform a method 300 for estimating costs in building construction with artificial intelligence (e.g., one or more artificial intelligence models 122). The method 300, in the illustrative embodiment, begins with block 302 in which the estimation compute device 110 obtains project planning data (e.g., the project planning data 120), which may be embodied as any data indicative of a planned construction of a building. The estimation compute device 110 may obtain the project planning data from a user compute device 150, 152 (e.g., transmitted via the network 180) or from another source. For example, the estimation compute device 110 may obtain the project planning data from a user (e.g., of a user compute device 150, 152) who is tasked with coordinating and planning the construction of a building in a particular geographic area or a person associated with a component manufacturer (e.g., a manufacturer of trusses used in the floors, walls, or roofs of a building or other components that may be at least partially manufactured prior to shipment to a construction site). In at least some embodiments, the estimation compute device 110 may obtain the project planning data via a user interface presented by a user compute device 150, 152 (e.g., a web based interface based on hypertext markup language (HTML), JavaScript, and image data (e.g., portable network graphics (PNG) files, graphics interchange format (GIF) files, or the like) or a native client (e.g., a software application executed locally by the corresponding user compute device 150, 152 that may interface with the estimation compute device 110 using one or more application programming interfaces (e.g., a representational state transfer (REST) API)).

In at least some embodiments, the estimation compute device 110 may obtain user preference data which may be embodied as any data indicative of a target confidence level for cost estimations, as indicated in block 304. That is, as described in more detail herein, the estimation compute device 110 utilizes one or more artificial intelligence models (e.g., the models 122) to produce an estimate (e.g., an inference or prediction) that may have an associated confidence level (e.g., a measure of expected accuracy of a prediction based on historical performance of the model). In at least some embodiments, the estimation compute device 110 may suppress or otherwise discard estimate data from any models having a confidence level that does not satisfy the target confidence level. As indicated in block 306, the estimation compute device 110, in the illustrative embodiment, obtains architecture drawing data indicative of one or more architectural drawings for the building to be constructed. In doing so, the estimation compute device 110 may obtain data indicative of a floor plan, as indicated in block 308. Additionally or alternatively, the estimation compute device 110 may obtain data indicative of a roof elevation plan, as indicated in block 310. The architectural drawing data may be embodied as one or more image files, documents files (e.g., portable document format (PDF), or other file formats. In some embodiments, the architectural drawings may include annotations (e.g., typed or handwritten) regarding properties (e.g., material types, measurements, loads or forces, etc.) of structural members, locations and/or identifiers of specialized equipment (e.g., fire wall hanger(s)) or components (e.g., trusses) to be used in the structure (e.g., building) represented in the architectural drawings.

In obtaining project planning data, the estimation compute device 110 may obtain data indicative of a geographic location for the building (e.g., where the building is to be constructed), as indicated in block 312. The geographic location may be expressed as a street address (e.g., in combination with a city, state, postal code and country), a plot identifier, latitude and longitude coordinates, or other designation of a geographic location. In at least some embodiments, the estimation compute device 110 may obtain data indicative of a geographic location of a component manufacturer that may be involved in the construction of the building (e.g., by supplying construction components, such as trusses), as indicated in block 314. Further, and as indicated in block 316, the estimation compute device 110 may obtain data indicative of a delivery date for any construction components (e.g., trusses). That is, the estimation compute device 110 may obtain data indicative of a date by which the construction components are to be delivered to the construction site (e.g., the geographic location for the building, from block 312) to maintain compliance with a target timeline for construction of the building. Relatedly, the estimation compute device 110 may obtain data indicative of a target completion date for the building (e.g., date on which construction is to be completed), as indicated in block 318.

Further, and as indicated in block 320, the estimation compute device 110 may obtain data indicative of equipment (e.g., non-standard or specialized equipment) to be utilized in the construction of the building. For example, and as indicated in block 322, the estimation compute device 110 may obtain data indicative of one or more fire wall hangers (e.g., a device designed for attaching truss, I-joist, solid sawn lumber, or engineered wood floor framing members to a fire-rated wood frame wall) to be utilized in the construction. As indicated in block 324, the estimation compute device 110 may determine whether the obtained data (e.g., constituting the project planning data) satisfies a data completeness threshold (e.g., a set of project planning data designated as a required or minimum set of data needed to produce an estimate). In response to a determination that the obtained data does not satisfy the data completeness threshold, the estimation compute device 110 may request additional project planning data, as indicated in block 326. The estimation compute device 110 may, in some embodiments, produce a notice that estimation operations may not proceed until the additional project planning data is obtained.

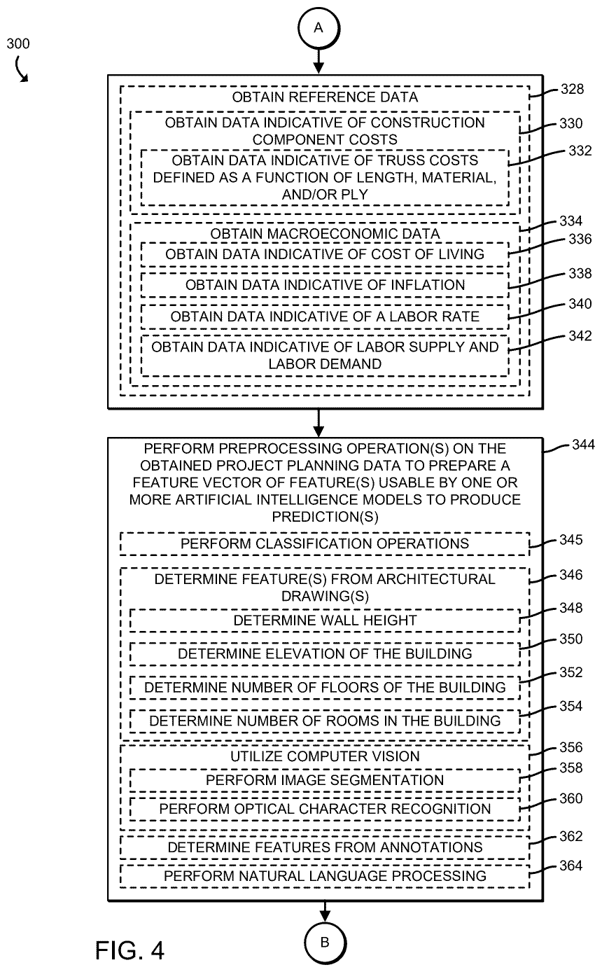

Referring now to FIG. 4, in some embodiments, the estimation compute device 110 may obtain reference data (e.g., reference data 124 of FIG. 1), as indicated in block 328. As indicated in block 330, in obtaining reference data, the estimation compute device 110 may obtain data indicative of construction component costs (e.g., from a corresponding data set 130, 132 or third party compute device 160). In doing so, the estimation compute device 110 may obtain data indicative of truss costs, which may be defined as a function of (e.g., vary based on) length, material, and/or ply, as indicated in block 332. For example, the estimation compute device 110 may provide, to the data set(s) 130, 132 or to the third party compute device 160, a request (e.g., a query) with parameters having values indicative of the length, material, and/or ply (e.g., based on the obtained architectural drawing data and/or other project planning data) and obtain a corresponding cost in response. The estimation compute device 110 may also obtain macroeconomic data (e.g., from a data set 130, 132 and/or the third party compute device 160), as indicated in block 334. In doing so, and as indicated in block 336, the estimation compute device 110 may obtain data indicative of a cost of living (e.g., in the geographic location for the building, from block 312). The estimation compute device 110 may obtain data indicative of inflation, as indicated in block 338. Additionally or alternatively, the estimation compute device 110 may obtain data indicative of a labor rate, as indicated in block 340. As indicated in block 342, the estimation compute device 110 may obtain data indicative of a labor supply and labor demand. In at least some embodiments, the estimation compute device 110 may obtain the macroeconomic data by querying a corresponding data set 130, 132 or third party compute device 160, identifying the requested data (cost of living, inflation, labor rate, and/or labor supply and demand) and an identifier of the geographic location (e.g., from block 312).

Continuing the method 300, the estimation compute device 110, in block 344, performs preprocessing operations on the obtained project planning data (e.g., from block 302). In doing so, the estimation compute device 110 prepares a feature vector (e.g., a data structure (e.g., written to memory 214 and/or data storage 222) containing a set of features (e.g., each a measured property or characteristic of an object or phenomenon that may be expressed in a numerical or categorical form)). The feature vector is usable by one or more artificial intelligence models (e.g., the models 122) to produce one or more predictions (e.g., pertaining to an estimated cost for construction of the building). That is, the feature vector provides data in a form that the artificial intelligence models 122 are configured to receive (e.g., as parameters or inputs). In doing so, the estimation compute device 110 may determine one or more features from the architectural drawing(s) (e.g., from block 306), as indicated in block 346. In determining features from the architectural drawings, the estimation compute device 110 may determine a wall height, as indicated in block 348. The estimation compute device 110 may also determine an elevation of the building, as indicated in block 350. Further, the estimation compute device 110 may determine a number of floors of the building, as indicated in block 352. Additionally, the estimation compute device 110 may determine a number of rooms in the building, as indicated in block 354. As indicated in block 356, in performing the determinations of blocks 348, 350, 352, 354, the estimation compute device 110 may utilize computer vision methods, which may be embodied in one or more of the artificial intelligence models 122 and/or based on a defined algorithm or combination of algorithms.

As indicated in block 358, the estimation compute device 110 may perform image segmentation (e.g., partitioning a digital image into multiple image segments (e.g., sets of pixels), such as for use by different artificial intelligence models 122 and/or to assist in identify objects and boundaries in the images). Additionally or alternatively, the estimation compute device 110 may perform optical character recognition (e.g., conversion of images of typed, handwritten or printed text into machine-encoded text), as indicated in block 360. The estimation compute device 110 may determine one or more of the features from annotations in the architectural drawings, as indicated in block 362. The annotations may be embodied as notes, which may be handwritten, typed, or printed and that may appear in a designated section of the architectural drawings or in connection with a structural member represented in the drawings. In the latter case, the estimation compute device 110 may determine that an annotation corresponds with a structural member closest to or pointed to by the annotation (e.g., by an arrow or line associated with an annotation). Relatedly, the estimation compute device 110 may perform natural language processing (e.g., operations to determine an ontological model representing a context and meaning of characters and words recognized in the architectural drawing(s)), as indicated in block 364. In some embodiments, the estimation compute device 110 may generate a three-dimensional model of the structure of the building based on available views represented in the architecture drawing data (e.g., from block 306). Conversely, the estimation compute device 110 may generate two-dimensional views from designated perspectives (e.g., floor plan view(s), elevation view(s), etc.) by projecting a three-dimensional model of the structure of the building onto a corresponding two-dimensional plane. As such, the estimation compute device 110 may supplement available project planning data that may otherwise be incomplete or insufficient for use by a human to determine an estimate for construction cost(s).

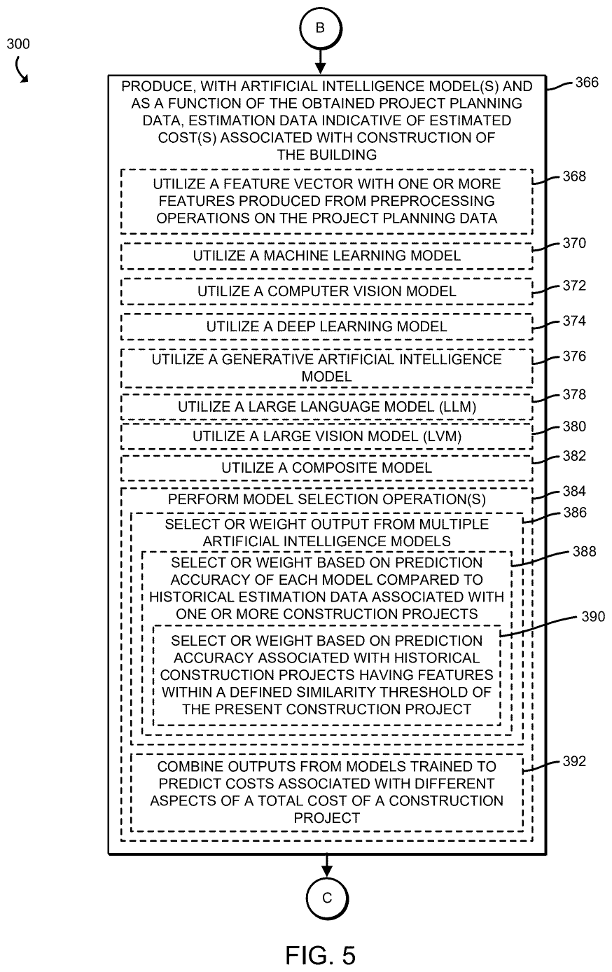

Referring now to FIG. 5, continuing the method 300, the estimation compute device 110 produces, with one or more artificial intelligence models (e.g., the artificial intelligence models 122) and as a function of the obtained project planning data (e.g., based on the project planning data 120 obtained in block 302), estimation data indicative of estimated cost(s) associated with construction of the building, as indicated in block 366. In doing so, and as indicated in block 368, the estimation compute device 110 may utilize a feature vector (e.g., in the memory 214 or data storage 222) with one or more features produced from preprocessing operations on the project planning data (e.g., from the preprocessing operations of block 344). As indicated in block 370, the estimation compute device 110 may utilize a machine learning model. A machine learning model may be embodied as a program to make predictions (e.g., also referred to as inferences) for a given data set and that may be configured or built by continually adapting weights, rules, or other aspects of the model (e.g., through a training process) to decrease an error in predictions (e.g., a difference between a correct prediction and a prediction produced by the machine learning model) to satisfy a target accuracy (e.g., inversely related to the error). The estimation compute device 110 may utilize a computer vision model (e.g., a program that uses machine learning to analyze image(s) and output information about objects detected in the image), as indicated in block 372. As indicated in block 374, the estimation compute device 110 may utilize a deep learning model (e.g., a neural network with three or more layers, wherein each layer passes on a more abstract representation of data to the next layer, to enable identification of patterns and relationships within relatively large data sets).

The estimation compute device 110 may utilize one or more generative artificial intelligence models, as indicated in block 376. Generative artificial intelligence models may be embodied as machine learning models that produce new data similar to data that they were trained on (e.g., based on supervised or unsupervised training). Generative artificial intelligence models may be adapted (e.g., from foundational models to specialized models) through additional training to fit specific domains. In some embodiments, the estimation compute device 110 may utilize one or more large language models (LLMs), as indicated in block 378. As referenced above, a large language model may be embodied as a type of generative artificial intelligence model trained on a relatively large amount of data (e.g., language oriented data, such as text) to emulate an understanding of human language. A large language model may be based on a transformer architecture, with multiple layers of neural networks, each having parameters that may be tuned during training. One or more additional layers, referred to as an attention layer, focuses the model on specific portions of a data set to increase the accuracy of the large language model in emulating human-like understanding of language. Further, the estimation compute device 110 may utilize a large vision model (LVM), as indicated in block 380. A large vision model may be embodied as a set of neural networks focused solely on processing visual data to perform object classification, object detection, image segmentation, and/or image generation. A large vision model may be trained to perform defect detection and object recognition with less labeled data than other computer vision models and may output bounding boxes, localize specific objects within an image, and discern information regarding spatial relationships (e.g., distances between objects) within an image. In at least some embodiments, the large vision model may have a transformer-based or convolutional neural network-based architecture. In embodiments in which the large vision model has a transformer-based architecture, the large vision model may be embodied as a vision transformer. Such a model may divide an image into patches and process each patch in a manner similar to words in a sentence, thereby enabling the capture of relatively long-range dependencies and global relationships within the image. The estimation compute device 110 may additionally or alternatively utilize a contrastive language-image pre-training (CLIP) model that is trained on a vast number of image-text pairs to associate images with their descriptions.

As indicated in block 382, the estimation compute device 110 may utilize a composite model, which may be embodied as a combination (e.g., an ensemble) of any of the models described above. In at least some embodiments, the estimation compute device 110 may perform model selection operations, as indicated in block 384. In doing so, the estimation compute device 110 may select or weight the output from multiple artificial intelligence models 122 for a final set of estimation data 126, as indicated in block 386. For example, the estimation compute device 110 may select or weight output from multiple artificial intelligence models 122 based on a prediction accuracy of each model 122 compared to historical estimation data associated with one or more construction projects (e.g., providing more weight to, or selecting the output of, a model 122 that has demonstrated a higher accuracy (compared to other models 122) in predicting costs associated with historical construction projects where the cost of each historical construction project is known), as indicated in block 388. The estimation compute device 110 may select or weight the output of models 122 based on a demonstrated prediction accuracy of each model 122 associated with historical construction projects having features within a defined (e.g., target) similarity threshold of the present construction project. That is, by mapping the features of the present feature vector and features of historical construction projects in a coordinate space, the estimation compute device 110 may determine a distance measure, such as a straight line distance (e.g., Euclidean distance) or a measure of an angle between feature vectors (e.g., Cosine distance).

As referenced above, a feature vector may be embodied as a set of numerical values, such as in an ordered list or array. As such, the feature vector may be mapped as a single point within a multi-dimensional coordinate space (i.e., a vector space or feature space). In the mapping, each individual feature within the vector directly corresponds to one of the orthogonal axes of the coordinate system. The numerical value of each feature then represents the specific coordinate along the corresponding axis. Doing so enables a complex object described by a vector to be represented as a geometrically quantifiable point, enabling the use of spatial measurements, such as distance and proximity to represent similarities or differences between various data points.

Additionally or alternatively, the estimation compute device 110 may determine a Jaccard index by determining an intersection over union (IoU), indicative of a ratio shared features to all of the features among multiple feature vectors (e.g., each corresponding to a construction project). That is, the estimation compute device 110 may identify and count the number of common elements (intersection) that are present in all of the feature vectors. Subsequently, the estimation compute device 110 may identify and count the number of elements that are present in any of the feature vectors (union). Afterwards, the estimation compute device 110 may divide the intersection by the union to obtain the Jaccard index, which falls into a range of zero to one, with zero representing no similarity and one representing identicality.

In at least some embodiments, the estimation compute device 110 may utilize principal component analysis or other dimensionality reduction techniques to focus a feature set to a reduced number of features that cause the most variation in (e.g., have the most impact on) the resulting estimation data. Doing so may reduce the complexity and computational resources (e.g., time, energy, circuitry) utilized to produce the estimation data, thereby enabling the estimation compute device 110 to operate more efficiently. As indicated in block 392, the estimation compute device 110 may combine outputs from models 122 trained to predict costs associated with different aspects of the total cost of the construction project. For example, one model 122 may have a higher demonstrated accuracy in predicting labor costs (e.g., based on macroeconomic data (e.g., from block 334) and a complexity of the structure (e.g., from the architectural drawings from block 306)) while another model 122 may have a higher demonstrated accuracy in determining material and/or shipping costs from the project planning data (e.g., obtained in block 302). By utilizing outputs from multiple models 122 based on their strengths (e.g., relative accuracy for different components of a total estimated cost), the estimation compute device 110 may increase the accuracy of the total cost estimate.

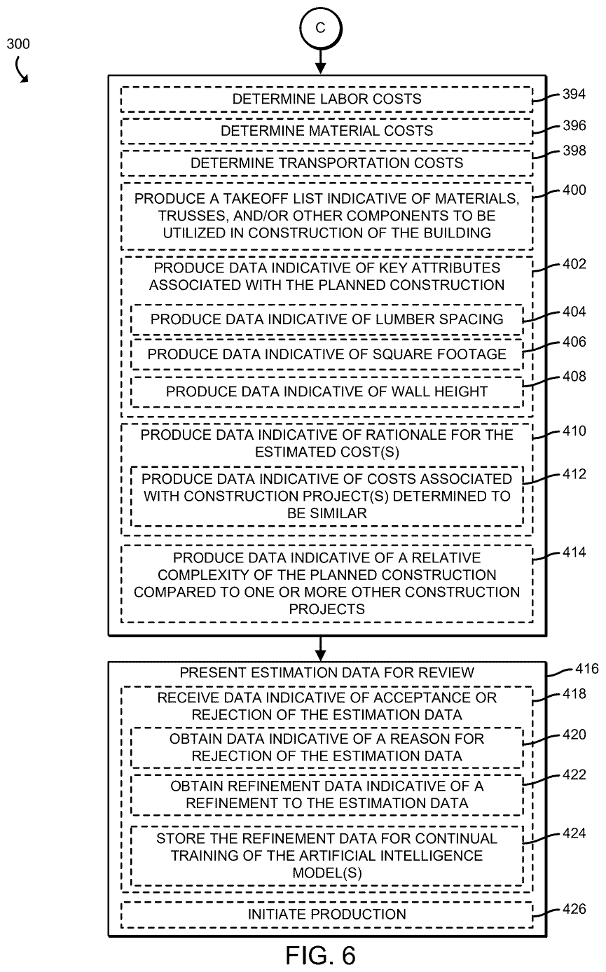

Referring now to FIG. 6, in block 394, the estimation compute device 110 may determine labor costs (e.g., a cost for construction personnel to construct the building at the geographic location for the building (e.g., identified in block 312)). As indicated in block 396, the estimation compute device 110 may determine the estimated labor cost based on the macroeconomic data (e.g., from block 334) associated with that geographic location, in addition to the size and/or complexity of the structure (e.g., as indicated in the architectural drawings from block 306). Similarly, the estimation compute device 110 may determine material costs (e.g., based on the construction component costs from block 330, special equipment to be utilized from block 320, and a size and/or complexity of the building, as indicated in the architectural drawings from block 306). The estimation compute device 110 may also determine transportation costs (e.g., based on the geographic location for the building from block 312, the geographic location(s) of any component manufacturers, from block 314, and the size and complexity of the building, as indicated in the architectural drawings from block 306), as indicated in block 398. Further, and as indicated in block 400, the estimation compute device 110 may also produce a takeoff list, which may be embodied as a list indicative of the materials, as well as trusses or other components, to be utilized in the construction of the building. Additionally, the estimation compute device 110 may produce data indicative of key (e.g., most significant) attributes associated with the planned construction, as indicated in block 402. In doing so, the estimation compute device 110 may produce data indicative of lumber spacing, as indicated in block 404. The estimation compute device 110 may also produce data indicative of the square footage of the building, as indicated in block 406. Further, the estimation compute device 110 may produce data indicative of wall height(s) for the building, as indicated in block 408. These key attributes (also referred to as key features) may additionally or alternatively include an applicable residential building code, data indicative of snow and/or wind load and pitch, overhang, or other attributes. In addition to using the key attributes (e.g., key features) for estimating the cost and takeoff list, in at least some embodiments, extraction of such key attributes can expedite the overall design process, as doing so eliminates the need for designers to scan through pages of project planning data manually to determine the information.

The estimation compute device 110 may produce data indicative of a rationale (e.g. reasons) for the estimated costs, as indicated in block 410. In doing so, the estimation compute device 110 may produce data indicative of costs associated with construction projects determined to be similar (e.g., based on a determination of similarity in the features between the presently planned construction and historical construction projects, using a Jaccard index or other similarity or distance measures described above), as indicated in block 412. The estimation compute device 110, in some embodiments, may produce data indicative of a relative complexity of the planned construction compared to one or more other construction projects (e.g., based on the square footage, geographic location, shipping costs, special equipment, and/or other factors), as indicated in block 414.

Further to the above, in at least some embodiments, the estimation compute device 110 may provide chain of thought reasoning. Instead of directly generating a final answer, the estimation compute device 110 may cause one or more of the artificial intelligence models 122 to produce indications (e.g., descriptions) of the intermediate steps that lead to an inference. In doing so, the estimation compute device 110 may cause a model 122, such as an LLM, to perform a series of logical steps in natural language before providing the final response. As such, the estimation compute device 122 may force a model 122 to break down complex queries into sub-problems, causing the internal reasoning process to be more observable and verifiable.

As will be appreciated, by forcing a model 122 to perform chain of thought reasoning and thereby follow to a structured and verifiable framework of determinations, the estimation compute device 110 may reduce the possibility of hallucinations. Hallucinations may occur when artificial intelligence models reach conclusions without following one or more intermediate steps or rely on superficial pattern matching. By forcing the model to produce a coherent sequence of intermediate steps, the estimation compute device 122 may ground an inference in a logical progression of determinations that, in the illustrative embodiment, are verifiable against training data utilized by the model 122 or the provided context. Doing so additionally may improve self-correction capabilities of the model 122. That is, the explicit breakdown of the inference process may act a form of internal validation, causing the model 122 to verify the consistency of its own intermediate results.

Subsequently, the estimation compute device 110 may present the estimation data (e.g., in a user interface displayed by a user compute device 150, 152) for review, as indicated in block 416. In doing so, and as indicated in block 418, the estimation compute device 110 may receive data indicative of acceptance or rejection of the presented estimation data (e.g., via selection of a corresponding user interface element indicative of acceptance or rejection). In the case of rejection, the estimation compute device 110 may obtain data (e.g., provided by a human reviewing the estimation data) indicative of a reason for rejection of the estimation data, as indicated in block 420. For example, a component of the estimation data (e.g., material cost) may differ from an expected estimate, as indicated in block 420. The estimation compute device 110 may obtain refinement data indicative of a refinement to the estimation data, as indicated in block 422. For example, the refinement data may indicate that cost information associated with a portion of the total cost is different than the amount estimated by the estimation compute device 110, such as because the number, size, and/or materials of the trusses differs from that determined by the estimation compute device 110. As indicated in block 424, the estimation compute device 110 may store the refinement data for use in continual training of the artificial intelligence models 122 (e.g., to increase the accuracy of future cost estimates). That is, in the illustrative embodiment, the artificial intelligence models 122 may be continually trained to incorporate refinements and updates to available data, thereby increasing the accuracy of cost predictions produced by the estimation compute device 110 over time. In doing so, the estimation compute device 110 may adapt the weights or selection of the outputs of the artificial intelligence models 122 as the accuracy of the models 122 changes relative to each other over time. As such, the operations described above improve the performance of the estimation compute device 110 over time. As indicated in block 426, in response to a determination that the estimation data satisfies applicable criteria (e.g., one or more expected costs), the system 100 may initiate production of one or more components of the building, such as by providing data indicative of the component(s) to be produced to one or more of the manufacturing devices 170, 172. In turn, the manufacturing device 170, 172 may manufacture components of the building to be transported to a construction site for integration into the building.

While the operations of the method 400 are described above in connection with planning the construction of an entire building, in other embodiments, the system 100 (e.g., the estimation compute device 110) may perform corresponding operations for planning the construction of one or more particular components of a building, such as one or more floor trusses, wall trusses, and/or roof trusses. That is, in at least some embodiments, the system 100 (e.g., the estimation compute device 110) may obtain component project planning data that is indicative of a planned construction of a building component (e.g., one or more trusses such as roof trusses or floor trusses, or one or more wall panels, or one or more engineered wood products, or other building components that may be premanufactured), similar to block 302 of FIG. 3. Further, the system 100 (e.g., the estimation compute device 110) may perform one or more preprocessing operations on the obtained component project planning data to prepare a feature vector of one or more features usable by an artificial intelligence model (e.g., one or more artificial intelligence models 122) to produce a prediction, similar to block 344 of FIG. 4.

To improve the operations of the system 100, such as by increasing the efficiency with which the operations are performed and to improve the accuracy of inferences by the artificial intelligence models 122, the system 100 may perform classification operations 345 that identify the class or type of information represented in each page and the class or type of document that represents the information. In doing so, the system 100 may utilize a multi-label page classifier that evaluates each page using OCR, an LLM, and/or an LVM and title blocks to determine the significance of each item (e.g., page) of obtained project planning data. Those pages may include pages of a roof plan, a floor plan, and/or other pages. The system 100 performs the classification operations as a preprocessing (e.g., pre-modeling step) before feeding the data to the core artificial intelligence models (e.g., the models 122) for analysis. A benefit of doing so is that designers and estimators are able to obtain the right information very quickly, as opposed to scrolling through the obtained project planning data page by page. A more technical benefit is that the classification operations provide efficiency, such as speed improvements and cost reduction (e.g., lower energy utilization) for subsequent models 122, as those downstream models 122 will utilize the content (e.g., the project planning data) in an order of priority, defined by the classification operations. Further, doing so improves the overall quality of estimate or design parameter extraction, particularly in cases of conflicting data.

By classifying the obtained data, the system 100 determines which pages of data should go to which downstream models 122, rather than providing all of the obtained data to all of the models 122. Further, the system 100 may determine an order or hierarchy of relevance of the data represented in the pages, and provide the data to the corresponding models 122 in a sequence associated with the relevance of each page for the corresponding type of information. For example, the system 100 may provide an initial set of pages to one or more corresponding models 122 to extract key data, such as roof slope, wall height, or other data, and may subsequently determine whether that initial set of pages provided the key data. If not, the system 100 may provide a subsequent set of pages, that have been assigned lower relevance or significance, to the corresponding models 122 to extract those items of data. Conversely, if the system 100 determines that the data was successfully extracted from the initial set of pages, then the system 100 may determine not to provide the subsequent set of pages to the models 122, as the required data has already been obtained. As such, they system 100 may avoid consuming energy and computational resources in evaluating additional pages of data for key information that has already been obtained from more authoritative sources for that information. As an example, for information indicative of the pitch of a roof, the system 100 may classify page(s) in the obtained project planning data representing the roof plans and assign a higher significance to those pages for roof pitch information than any other pages of the obtained project planning data.

In an example implementation, the system 100 may utilize a data structure that defines a class of project planning data (e.g., classification of pages) and the corresponding downstream models assigned to receive that class of project planning data. The data structure may, for example, indicate that roof pitch data (e.g., pages of project planning data that represent roof pitch) should be provided to an OCR model, while pages of project planning data that represent level-level heights, indicative how many levels are present in the building and the height of each level, should be routed to an LLM, computer vision model(s) (LVM), and/or an OCR model, the results of which may be combined to reach a result. In addition to enabling efficient routing of project planning data (e.g., pages) to corresponding models 122, the classification operations, enable efficient resolution of conflicts in the information represented in the pages of the project planning data. The system 100 may do so using a data structure that identifies a degree of authority or trustworthiness (e.g., relevance) for different potential sources or types of documents from which a given type of information may originate. Accordingly, the system 100 may provide more weight to information originating from a document having higher relevance than conflicting data originating from pages of a document that has been assigned (e.g., in the data structure) lower relevance for that type of information. For example, the system 100 may assign more relevance to and resolve conflicts in favor of building code data from 2025 as compared to building code data from 2020 (e.g., based on the recency of the data). Further, the classification operations may define a set of rules or guardrails to be provided to a downstream model that restrict the analysis or output of the model(s) 122, thereby increasing the accuracy of the inferences of those models 122. For example the classification operations may provide a set of rules that may indicate that any information determined to originate from a defined date range (e.g., any time after the present date) should be disregarded completely. As another example, the classification operations may provide a range of relevant values for a given type of information and a rule that indicates that for any values falling outside of the corresponding range, the value(s) should be disregarded. For example, the system 100 may provide, in a set of rules (e.g., in a prompt), a range of relevant roof pitch values with an instruction indicating that any values represented in the project planning data received by the downstream model(s) 122 indicating value(s) outside of that range should be disregarded.

Further, the system 100 (e.g., the estimation compute device 110) may produce, with the artificial intelligence model (e.g., one or more artificial intelligence models 122) and as a function of the obtained component project planning data and the feature vector, estimation data indicative of an estimated cost associated with construction of the building component, similar to the operations of block 366 of FIG. 5. Additionally, the system 100 (e.g., the estimation compute device 110) may present the estimation data indicative of the estimated cost associated with construction of the building component, similar to the operations of block 416 of FIG. 6.

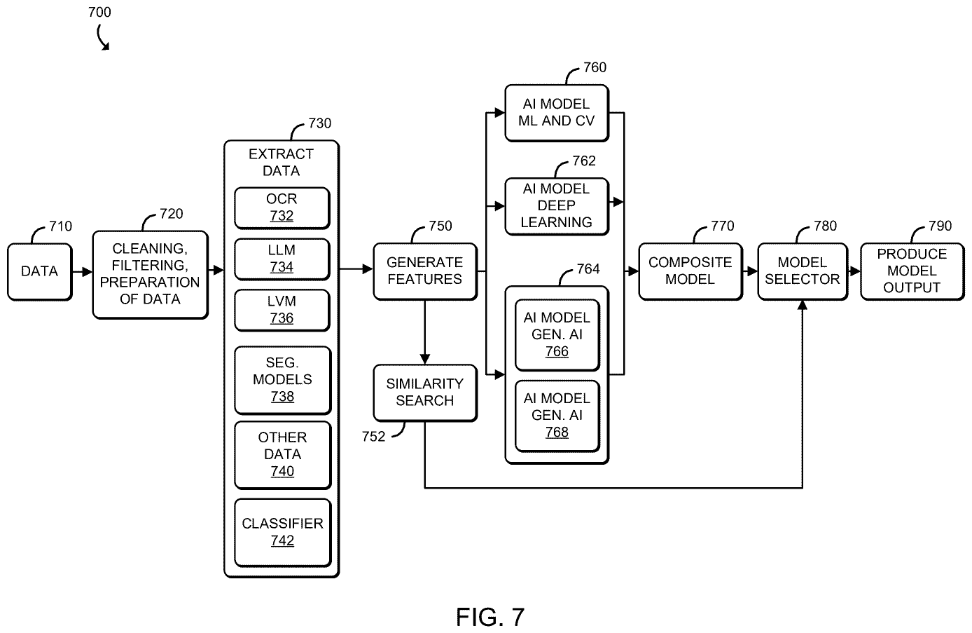

Referring now to FIG. 7, a diagram 700 of operations that may be performed by the estimation compute device 110 include obtaining data in block 710, cleaning, filtering, and preparing the data, in block 720, extracting data in block 730, such as performing optical character recognition, utilizing a large language model 734 to interpret recognized characters and words, utilizing a large vision model 736 to identify and classify objects and determine spatial relationships between the objects in the obtained data, utilizing one or more segmentation (e.g., image segmentation) models 738 to separate images in the obtained data into sub-sets (e.g., of pixels), and/or extracting other data 740 from the obtained data from block 710. Further, the estimation compute device 110 may perform classifier operations 742, such as those described relative to block 345 of the method 300. As described above, those operations may improve the efficiency of the estimation compute device 110, by restricting the set of data to be analyzed by each model 122 and enabling efficient resolution of conflicts in the data, to increase the accuracy of the results (e.g., inferences) of the models 122. The operations performed by the estimation compute device 110 may additionally include generating features (e.g., the feature vector, described above) in block 750 and providing the features to a set of models (e.g., the artificial intelligence models 122). Those models may include an artificial intelligence model 760 based on machine learning and machine vision, an artificial intelligence model 762 based on deep learning, and/or a combination 764 of artificial intelligence models 766, 768 based on generative artificial intelligence. The output of the models 760, 762, 766, 768 may be provided to a composite model 770 and the estimation compute device 110 may perform model selector operations 780 (e.g., the selection or weighting of output from the models 760, 762, 764, 766, similar to block 384 of the method 300). In doing so, the estimation compute device 110 may utilize the results of a similarity search 752 (e.g., a measure of similarity in the features of the presently planned construction compared to historical construction projects, as discussed in connection with blocks 388, 390 of the method 300) to inform the model selector operations 780. Further, the estimation compute device 110 produces model output (e.g., the estimate of the cost, which may be broken down into components) in block 790 (e.g., similar to block 416 of the method 300).

The following table indicates modeling approaches that may be to establish and train models (e.g., artificial intelligence models 122) and that may be utilized the estimation compute device 110 in the operations described above.

TABLE 1
Modeling Approaches.

| Approach | Operation |
|---|---|
| Machine Learning | Data Set Splitting (Dividing the data set into |
| Development | training, validation, and test sets) |
| | Model Training (Using the training data to |
| | train the machine learning model) |
| | Model Testing (Evaluating the trained model |
| | on the test data to assess the performance of |
| | the model) |
| | Model Validation (Fine tuning the model using |
| | the validation set to improve performance of |
| | the model) |
| | Model Reiteration and Retraining (Repeating |
| | the training process with adjusted parameters |
| | to improve accuracy) |
| Deep Learning Model | Data Set Splitting (Dividing the data set into |
| Development | training, validation, and test sets) |
| | Model Training and Architecture Selection |
| | (Choosing the appropriate architecture and |
| | training the deep learning model) |
| | Model Testing (Evaluating the trained model |
| | on the test data to assess the performance of |
| | the model) |
| | Model Validation (Fine tuning the model using |
| | the validation set to improve performance) |
| | Model Reiteration and Retraining (Repeating |
| | the training process with adjusted parameters |
| | to improve accuracy) |
| Fine Tuning and Transfer | Model Selection (Choosing a pre-trained |
| Learning | model suitable for the task) |
| | Data Set Splitting (Dividing the data set |
| | into training, validation, and test sets) |
| | Model Training (Fine tuning the pre-trained |
| | model on the new data set) |
| | Model Testing (Evaluating the fine-tuned |
| | model on the test data to assess the |
| | performance of the model) |
| | Model Validation (Fine tuning the model using |
| | the validation set to improve performance) |
| | Model Reiteration and Retraining (Repeating |
| | the training process with adjusted parameters |
| | to improve accuracy) |
| Generative Artificial | Multimodal (Using multiple data types (e.g., |
| Intelligence and Other | text, images, audio) for training models) |
| Model Evaluation | |
| | Auto Machine Learning (Automated machine |
| | learning techniques to streamline model |
| | selection and training) |
| | Prompt Engineering (Designing and |
| | optimizing prompts to improve AI model |
| | responses) |
| | Segmentation Techniques (Dividing data into |
| | meaningful segments to improve model |
| | performance) |

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. Additional embodiments may be described in the attached appendix. There exists a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.
Example 1 includes a system comprising circuitry configured to obtain project planning data indicative of a planned construction of a building; perform one or more preprocessing operations on the obtained project planning data to prepare a feature vector of one or more features usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data; produce, with each determined subset of artificial intelligence models associated with each identified class and as a function of the obtained project planning data and the feature vector, estimation data indicative of an estimated cost associated with construction of the building; and present the estimation data.
Example 2 includes the subject matter of Example 1, and wherein the circuitry is further configured to initiate, with one or more manufacturing devices, production of one or more components of the building in response to a determination that the estimation data satisfies corresponding criteria.
Example 3 includes the subject matter of any of Examples 1 and 2, and wherein the circuitry is further configured to define a set of rules to be provided to one or more artificial intelligence models of a corresponding subset to restrict an analysis of the one or more artificial intelligence models and to increase an accuracy of an inference produced by the one or more artificial intelligence models.
Example 4 includes the subject matter of any of Examples 1-3, and wherein one or more items of the obtained project planning data is representative of a page of a corresponding document and wherein to perform classification operations comprises to determine a class of at least one item with one or more of optical character recognition or natural language processing.
Example 5 includes the subject matter of any of Examples 1-4, and wherein the circuitry is further configured to determine, as a function of the classes, a relative importance of each item of obtained project data; and resolve one or more conflicts among items of the obtained project data as a function of the determined relative importance of each item of obtained project data.
Example 6 includes the subject matter of any of Examples 1-5, and wherein the circuitry is further configured to determine, as a function of the classes, a relative importance of each item of obtained project data; and limit an amount of the items of the obtained project planning data to be provided to the set of artificial intelligence models as a function of the determined relative importance of each item of the obtained project data to increase a computational efficiency in the production of an inference, by the set of artificial intelligence models, indicative of the estimation data.
Example 7 includes the subject matter of any of Examples 1-6, and wherein the circuitry is further configured to cause one or more of the artificial intelligence models to perform chain of thought reasoning to produce at least a portion of the estimation data, to reduce a likelihood of hallucination by the one or more artificial intelligence models; and present a representation of the chain of thought reasoning with the estimation data.
Example 8 includes the subject matter of any of Examples 1-7, and wherein to obtain project planning data comprises to obtain architecture drawing data indicative of one or more architectural drawings of the building.
Example 9 includes the subject matter of any of Examples 1-8, and wherein to obtain architecture drawing data comprises to obtain data indicative of a floor plan.
Example 10 includes the subject matter of any of Examples 1-9, and wherein to obtain architecture drawing data comprises to obtain data indicative of a roof elevation plan.
Example 11 includes the subject matter of any of Examples 1-10, and wherein to obtain project planning data comprises to obtain data indicative of a geographic location for the building.
Example 12 includes the subject matter of any of Examples 1-11, and wherein to obtain project planning data comprises to obtain data indicative of a geographic location of a component manufacturer for at least one component of the building.
Example 13 includes the subject matter of any of Examples 1-12, and wherein to obtain project planning data comprises to obtain data indicative of a delivery date for one or more construction components.
Example 14 includes the subject matter of any of Examples 1-13, and wherein to obtain project planning data comprises to obtain data indicative of a target completion date for the building.
Example 15 includes the subject matter of any of Examples 1-14, and wherein to obtain project planning data comprises to obtain data indicative of equipment to be utilized in the construction.
Example 16 includes the subject matter of any of Examples 1-15, and wherein to obtain data indicative of equipment to be utilized comprises to obtain data indicative of a fire wall hanger to be utilized.
Example 17 includes the subject matter of any of Examples 1-16, and wherein to obtain project planning data comprises to determine whether the obtained data satisfies a data completeness threshold; and request, in response to a determination that the obtained data does not satisfy the data completeness threshold, additional project planning data.
Example 18 includes the subject matter of any of Examples 1-17, and wherein to obtain project planning data comprises to obtain reference data indicative of construction component costs.
Example 19 includes the subject matter of any of Examples 1-18, and wherein to obtain reference data indicative of construction component costs comprises to obtain data indicative of truss costs defined as a function of length, material, or ply.
Example 20 includes the subject matter of any of Examples 1-19, and wherein to obtain project planning data comprises to obtain reference data indicative of macroeconomic data.
Example 21 includes the subject matter of any of Examples 1-20, and wherein to obtain macroeconomic data comprises to obtain data indicative of a cost of living, inflation, a labor rate, or labor supply and demand associated with a geographic area for the planned construction.
Example 22 includes the subject matter of any of Examples 1-21, and wherein to perform one or more preprocessing operations comprises to determine features from architectural drawings in the obtained project planning data.
Example 23 includes the subject matter of any of Examples 1-22, and wherein to determine features from architectural drawings comprises to determine a wall height, an elevation of the building, a number of floors of the building, or a number of rooms in the building.
Example 24 includes the subject matter of any of Examples 1-23, and wherein to perform one or more preprocessing operations comprises to utilize computer vision on the obtained project planning data.
Example 25 includes the subject matter of any of Examples 1-24, and wherein to utilize computer vision comprises to perform at least one of image segmentation or optical character recognition.
Example 26 includes the subject matter of any of Examples 1-25, and wherein to perform one or more preprocessing operations comprises to determine features from annotations in the project planning data.
Example 27 includes the subject matter of any of Examples 1-26, and wherein to perform one or more preprocessing operations comprises to perform natural language processing on the project planning data.
Example 28 includes the subject matter of any of Examples 1-27, and wherein to produce, with an artificial intelligence model, estimation data comprises to utilize a machine learning model to produce the estimation data.
Example 29 includes the subject matter of any of Examples 1-28, and wherein to produce, with an artificial intelligence model, estimation data comprises to utilize a computer vision model to produce the estimation data.
Example 30 includes the subject matter of any of Examples 1-29, and wherein to produce, with an artificial intelligence model, estimation data comprises to utilize a deep learning model to produce the estimation data.
Example 31 includes the subject matter of any of Examples 1-30, and wherein to produce, with an artificial intelligence model, estimation data comprises to utilize a generative artificial intelligence to produce the estimation data.
Example 32 includes the subject matter of any of Examples 1-31, and wherein to produce, with an artificial intelligence model, estimation data comprises to utilize a large language model to produce the estimation data.
Example 33 includes the subject matter of any of Examples 1-32, and wherein to produce, with an artificial intelligence model, estimation data comprises to utilize a large vision model to produce the estimation data.
Example 34 includes the subject matter of any of Examples 1-33, and wherein to produce, with an artificial intelligence model, estimation data comprises to utilize a composite model of multiple artificial intelligence models to produce the estimation data.
Example 35 includes the subject matter of any of Examples 1-34, and wherein to produce, with an artificial intelligence model, estimation data comprises to perform one or more model selection operations.
Example 36 includes the subject matter of any of Examples 1-35, and wherein to perform one or more model selection operations comprises to select or weight output from multiple artificial intelligence models.
Example 37 includes the subject matter of any of Examples 1-36, and wherein to select or weight output comprises to select or weight the output based on a prediction accuracy of each artificial intelligence model compared to historical estimation data associated with historical construction projects.
Example 38 includes the subject matter of any of Examples 1-37, and wherein the circuitry is further to select or weight the output based on prediction accuracy associated with historical construction projects having features within a defined similarly threshold of features in the feature vector.
Example 39 includes the subject matter of any of Examples 1-38, and wherein to perform one or more model selection operations comprises to combine output from models trained to predict costs associated with different aspects of the total cost of a construction project.
Example 40 includes the subject matter of any of Examples 1-39, and wherein to produce, with an artificial intelligence model, estimation data comprises to determine a labor cost for the planned construction.
Example 41 includes the subject matter of any of Examples 1-40, and wherein to produce, with an artificial intelligence model, estimation data comprises to determine a material cost for the planned construction.
Example 42 includes the subject matter of any of Examples 1-41, and wherein to produce, with an artificial intelligence model, estimation data comprises to determine a transportation cost for the planned construction.
Example 43 includes the subject matter of any of Examples 1-42, and wherein the circuitry is further configured to produce a takeoff list indicative of materials and trusses to be utilize in the planned construction of the building.
Example 44 includes the subject matter of any of Examples 1-43, and wherein the circuitry is further configured to produce data indicative of key attributes determined to have the greatest influence on the estimated cost associated with the planned construction.
Example 45 includes the subject matter of any of Examples 1-44, and wherein to produce data indicative of key attributes comprises to produce data indicative of lumber spacing, square footage, or wall height.
Example 46 includes the subject matter of any of Examples 1-45, and wherein to produce estimation data comprises to produce data indicative of a rationale for the estimated cost.
Example 47 includes the subject matter of any of Examples 1-46, and wherein to produce data indicative of a rationale comprises to produce data indicative of a cost associated with a historical construction project determined to be similar to the planned construction.
Example 48 includes the subject matter of any of Examples 1-47, and wherein to produce estimation data comprises to produce data indicative of a relative complexity of the planned construction compared to one or more other construction projects.
Example 49 includes the subject matter of any of Examples 1-48, and wherein the circuitry is further configured to receive data indicative of acceptance or rejection of the estimation data.
Example 50 includes the subject matter of any of Examples 1-49, and wherein to receive data indicative of acceptance or rejection of the estimation data comprises to obtain data indicative of a reason for rejection of the estimation data; obtain refinement data indicative of a refinement to the estimation data; and store the refinement data for continual training of the artificial intelligence model.
Example 51 includes the subject matter of any of Examples 1-50, and wherein the circuitry is further configured to obtain component project planning data indicative of a planned construction of a building component; perform one or more preprocessing operations on the obtained component project planning data to prepare a second feature vector of one or more features usable by an artificial intelligence model to produce a prediction; produce, with the artificial intelligence model and as a function of the obtained component project planning data and the second feature vector, estimation data indicative of an estimated cost associated with construction of the building component; and present the estimation data.
Example 52 includes a method comprising obtaining, by a compute device, project planning data indicative of a planned construction of a building; performing, by the compute device, one or more preprocessing operations on the obtained project planning data to prepare a feature vector of one or more features usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data; producing, by the compute device, with each determined subset of artificial intelligence models associated with each identified class and as a function of the obtained project planning data and the feature vector, estimation data indicative of an estimated cost associated with construction of the building; and present the estimation data.
Example 53 includes the subject matter of Example 52, and further including initiating, with one or more manufacturing devices, production of one or more components of the building in response to a determination that the estimation data satisfies corresponding criteria.
Example 54 includes the subject matter of any of Examples 52 and 53, and further including defining a set of rules to be provided to one or more artificial intelligence models of a corresponding subset to restrict an analysis of the one or more artificial intelligence models and to increase an accuracy of an inference produced by the one or more artificial intelligence models.
Example 55 includes the subject matter of any of Examples 52-54, and wherein one or more items of the obtained project planning data is representative of a page of a corresponding document and wherein performing classification operations comprises determining a class of at least one item with one or more of optical character recognition or natural language processing.
Example 56 includes the subject matter of any of Examples 52-55, and further including determining, as a function of the classes, a relative importance of each item of obtained project data; and resolving one or more conflicts among items of the obtained project data as a function of the determined relative importance of each item of obtained project data.
Example 57 includes the subject matter of any of Examples 52-56, and further including determining, as a function of the classes, a relative importance of each item of obtained project data; and limiting an amount of the items of the obtained project planning data to be provided to the set of artificial intelligence models as a function of the determined relative importance of each item of the obtained project data to increase a computational efficiency in the production of an inference, by the set of artificial intelligence models, indicative of the estimation data.
Example 58 includes the subject matter of any of Examples 52-57, and further including causing one or more of the artificial intelligence models to perform chain of thought reasoning to produce at least a portion of the estimation data, to reduce a likelihood of hallucination by the one or more artificial intelligence models; and presenting a representation of the chain of thought reasoning with the estimation data.
Example 59 includes the subject matter of any of Examples 52-58, and wherein obtaining project planning data comprises obtaining architecture drawing data indicative of one or more architectural drawings of the building.
Example 60 includes the subject matter of any of Examples 52-59, and wherein obtaining architecture drawing data comprises obtaining data indicative of a floor plan.
Example 61 includes the subject matter of any of Examples 52-60, and wherein obtaining architecture drawing data comprises obtaining data indicative of a roof elevation plan.
Example 62 includes the subject matter of any of Examples 52-61, and wherein obtaining project planning data comprises obtaining data indicative of a geographic location for the building.
Example 63 includes the subject matter of any of Examples 52-62, and wherein obtaining project planning data comprises obtaining data indicative of a geographic location of a component manufacturer for at least one component of the building.
Example 64 includes the subject matter of any of Examples 52-63, and wherein obtaining project planning data comprises obtaining data indicative of a delivery date for one or more construction components.
Example 65 includes the subject matter of any of Examples 52-64, and wherein obtaining project planning data comprises obtaining data indicative of a target completion date for the building.
Example 66 includes the subject matter of any of Examples 52-65, and wherein obtaining project planning data comprises obtaining data indicative of equipment to be utilized in the construction.
Example 67 includes the subject matter of any of Examples 52-66, and wherein obtaining data indicative of equipment to be utilized comprises obtaining data indicative of a fire wall hanger to be utilized.
Example 68 includes the subject matter of any of Examples 52-67, and wherein obtaining project planning data comprises determining whether the obtained data satisfies a data completeness threshold; and requesting, in response to a determination that the obtained data does not satisfy the data completeness threshold, additional project planning data.
Example 69 includes the subject matter of any of Examples 52-68, and wherein obtaining project planning data comprises obtaining reference data indicative of construction component costs.
Example 70 includes the subject matter of any of Examples 52-69, and wherein obtaining reference data indicative of construction component costs comprises obtaining data indicative of truss costs defined as a function of length, material, or ply.
Example 71 includes the subject matter of any of Examples 52-70, and wherein obtaining project planning data comprises obtaining reference data indicative of macroeconomic data.
Example 72 includes the subject matter of any of Examples 52-71, and wherein obtaining macroeconomic data comprises obtaining data indicative of a cost of living, inflation, a labor rate, or labor supply and demand associated with a geographic area for the planned construction.
Example 73 includes the subject matter of any of Examples 52-72, and wherein performing one or more preprocessing operations comprises determining features from architectural drawings in the obtained project planning data.
Example 74 includes the subject matter of any of Examples 52-73, and wherein determining features from architectural drawings comprises determining a wall height, an elevation of the building, a number of floors of the building, or a number of rooms in the building.
Example 75 includes the subject matter of any of Examples 52-74, and wherein performing one or more preprocessing operations comprises utilizing computer vision on the obtained project planning data.
Example 76 includes the subject matter of any of Examples 52-75, and wherein utilizing computer vision comprises performing at least one of image segmentation or optical character recognition.
Example 77 includes the subject matter of any of Examples 52-76, and wherein performing one or more preprocessing operations comprises determining features from annotations in the project planning data.
Example 78 includes the subject matter of any of Examples 52-77, and wherein performing one or more preprocessing operations comprises performing natural language processing on the project planning data.
Example 79 includes the subject matter of any of Examples 52-78, and wherein producing, with an artificial intelligence model, estimation data comprises utilizing a machine learning model to produce the estimation data.
Example 80 includes the subject matter of any of Examples 52-79, and wherein producing, with an artificial intelligence model, estimation data comprises utilizing a computer vision model to produce the estimation data.
Example 81 includes the subject matter of any of Examples 52-80, and wherein producing, with an artificial intelligence model, estimation data comprises utilizing a deep learning model to produce the estimation data.
Example 82 includes the subject matter of any of Examples 52-81, and wherein producing, with an artificial intelligence model, estimation data comprises utilizing a generative artificial intelligence to produce the estimation data.
Example 83 includes the subject matter of any of Examples 52-82, and wherein producing, with an artificial intelligence model, estimation data comprises utilizing a large language model to produce the estimation data.
Example 84 includes the subject matter of any of Examples 52-83, and wherein producing, with an artificial intelligence model, estimation data comprises utilizing a large vision model to produce the estimation data.
Example 85 includes the subject matter of any of Examples 52-84, and wherein producing, with an artificial intelligence model, estimation data comprises utilizing a composite model of multiple artificial intelligence models to produce the estimation data.
Example 86 includes the subject matter of any of Examples 52-85, and wherein producing, with an artificial intelligence model, estimation data comprises performing one or more model selection operations.
Example 87 includes the subject matter of any of Examples 52-86, and wherein performing one or more model selection operations comprises selecting or weighting output from multiple artificial intelligence models.
Example 88 includes the subject matter of any of Examples 52-87, and wherein selecting or weighting output comprises selecting or weighting the output based on a prediction accuracy of each artificial intelligence model compared to historical estimation data associated with historical construction projects.
Example 89 includes the subject matter of any of Examples 52-88, and further including selecting or weighting the output based on prediction accuracy associated with historical construction projects having features within a defined similarly threshold of features in the feature vector.
Example 90 includes the subject matter of any of Examples 52-89, and wherein performing one or more model selection operations comprises combining output from models trained to predict costs associated with different aspects of the total cost of a construction project.
Example 91 includes the subject matter of any of Examples 52-90, and wherein producing, with an artificial intelligence model, estimation data comprises determining a labor cost for the planned construction.
Example 92 includes the subject matter of any of Examples 52-91, and wherein producing, with an artificial intelligence model, estimation data comprises determining a material cost for the planned construction.
Example 93 includes the subject matter of any of Examples 52-92, and wherein producing, with an artificial intelligence model, estimation data comprises determining a transportation cost for the planned construction.
Example 94 includes the subject matter of any of Examples 52-93, and further including producing a takeoff list indicative of materials and trusses to be utilize in the planned construction of the building.
Example 95 includes the subject matter of any of Examples 52-94, and further including producing data indicative of key attributes determined to have the greatest influence on the estimated cost associated with the planned construction.
Example 96 includes the subject matter of any of Examples 52-95, and wherein producing data indicative of key attributes comprises producing data indicative of lumber spacing, square footage, or wall height.
Example 97 includes the subject matter of any of Examples 52-96, and wherein producing estimation data comprises producing data indicative of a rationale for the estimated cost.
Example 98 includes the subject matter of any of Examples 52-97, and wherein producing data indicative of a rationale comprises producing data indicative of a cost associated with a historical construction project determined to be similar to the planned construction.
Example 99 includes the subject matter of any of Examples 52-98, and wherein producing estimation data comprises producing data indicative of a relative complexity of the planned construction compared to one or more other construction projects.
Example 100 includes the subject matter of any of Examples 52-99, and further including receiving data indicative of acceptance or rejection of the estimation data.
Example 101 includes the subject matter of any of Examples 52-100, and wherein receiving data indicative of acceptance or rejection of the estimation data comprises obtaining data indicative of a reason for rejection of the estimation data; obtaining refinement data indicative of a refinement to the estimation data; and storing the refinement data for continual training of the artificial intelligence model.
Example 102 includes the subject matter of any of Examples 52-101, and further including obtaining component project planning data indicative of a planned construction of a building component; performing one or more preprocessing operations on the obtained component project planning data to prepare a feature vector of one or more features usable by an artificial intelligence model to produce a prediction; producing, with the artificial intelligence model and as a function of the obtained component project planning data and the feature vector, estimation data indicative of an estimated cost associated with construction of the building component; and presenting the estimation data.
Example 103 includes one or more machine-readable storage media comprising a plurality of instructions stored thereon that, in response to being executed, cause a system to obtain project planning data indicative of a planned construction of a building; perform one or more preprocessing operations on the obtained project planning data to prepare a feature vector of one or more features usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data; produce, with each determined subset of artificial intelligence models associated with each identified class and as a function of the obtained project planning data and the feature vector, estimation data indicative of an estimated cost associated with construction of the building; and present the estimation data.
Example 104 includes the subject matter of Example 103, and wherein the instructions additionally cause the system to initiate, with one or more manufacturing devices, production of one or more components of the building in response to a determination that the estimation data satisfies corresponding criteria.
Example 105 includes the subject matter of any of Examples 103 and 104, and wherein the instructions additionally cause the system to define a set of rules to be provided to one or more artificial intelligence models of a corresponding subset to restrict an analysis of the one or more artificial intelligence models and to increase an accuracy of an inference produced by the one or more artificial intelligence models.
Example 106 includes the subject matter of any of Examples 103-105, and wherein one or more items of the obtained project planning data is representative of a page of a corresponding document and wherein to perform classification operations comprises to determine a class of at least one item with one or more of optical character recognition or natural language processing.
Example 107 includes the subject matter of any of Examples 103-106, and wherein the instructions additionally cause the system to determine, as a function of the classes, a relative importance of each item of obtained project data; and resolve one or more conflicts among items of the obtained project data as a function of the determined relative importance of each item of obtained project data.
Example 108 includes the subject matter of any of Examples 103-107, and wherein the instructions additionally cause the system to determine, as a function of the classes, a relative importance of each item of obtained project data; and limit an amount of the items of the obtained project planning data to be provided to the set of artificial intelligence models as a function of the determined relative importance of each item of the obtained project data to increase a computational efficiency in the production of an inference, by the set of artificial intelligence models, indicative of the estimation data.
Example 109 includes the subject matter of any of Examples 103-108, and wherein the instructions additionally cause the system to cause one or more of the artificial intelligence models to perform chain of thought reasoning to produce at least a portion of the estimation data, to reduce a likelihood of hallucination by the one or more artificial intelligence models; and present a representation of the chain of thought reasoning with the estimation data.
Example 110 includes the subject matter of any of Examples 103-109, and wherein to obtain project planning data comprises to obtain architecture drawing data indicative of one or more architectural drawings of the building.
Example 111 includes the subject matter of any of Examples 103-110, and wherein to obtain architecture drawing data comprises to obtain data indicative of a floor plan.
Example 112 includes the subject matter of any of Examples 103-111, and wherein to obtain architecture drawing data comprises to obtain data indicative of a roof elevation plan.
Example 113 includes the subject matter of any of Examples 103-112, and wherein to obtain project planning data comprises to obtain data indicative of a geographic location for the building.
Example 114 includes the subject matter of any of Examples 103-113, and wherein to obtain project planning data comprises to obtain data indicative of a geographic location of a component manufacturer for at least one component of the building.
Example 115 includes the subject matter of any of Examples 103-114, and wherein to obtain project planning data comprises obtaining data indicative of a delivery date for one or more construction components.
Example 116 includes the subject matter of any of Examples 103-115, and wherein to obtain project planning data comprises to obtain data indicative of a target completion date for the building.
Example 117 includes the subject matter of any of Examples 103-116, and wherein to obtain project planning data comprises to obtain data indicative of equipment to be utilized in the construction.
Example 118 includes the subject matter of any of Examples 103-117, and wherein to obtain data indicative of equipment to be utilized comprises to obtain data indicative of a fire wall hanger to be utilized.
Example 119 includes the subject matter of any of Examples 103-118, and wherein to obtain project planning data comprises to determine whether the obtained data satisfies a data completeness threshold; and request, in response to a determination that the obtained data does not satisfy the data completeness threshold, additional project planning data.
Example 120 includes the subject matter of any of Examples 103-119, and wherein to obtain project planning data comprises to obtain reference data indicative of construction component costs.
Example 121 includes the subject matter of any of Examples 103-120, and wherein to obtain reference data indicative of construction component costs comprises to obtain data indicative of truss costs defined as a function of length, material, or ply.
Example 122 includes the subject matter of any of Examples 103-121, and wherein to obtain project planning data comprises to obtain reference data indicative of macroeconomic data.
Example 123 includes the subject matter of any of Examples 103-122, and wherein to obtain macroeconomic data comprises to obtain data indicative of a cost of living, inflation, a labor rate, or labor supply and demand associated with a geographic area for the planned construction.
Example 124 includes the subject matter of any of Examples 103-123, and wherein to perform one or more preprocessing operations comprises to determine features from architectural drawings in the obtained project planning data.
Example 125 includes the subject matter of any of Examples 103-124, and wherein to determine features from architectural drawings comprises to determine a wall height, an elevation of the building, a number of floors of the building, or a number of rooms in the building.
Example 126 includes the subject matter of any of Examples 103-125, and wherein to perform one or more preprocessing operations comprises to utilize computer vision on the obtained project planning data.
Example 127 includes the subject matter of any of Examples 103-126, and wherein to utilize computer vision comprises to perform at least one of image segmentation or optical character recognition.
Example 128 includes the subject matter of any of Examples 103-127, and wherein to perform one or more preprocessing operations comprises to determine features from annotations in the project planning data.
Example 129 includes the subject matter of any of Examples 103-128, and wherein to perform one or more preprocessing operations comprises to perform natural language processing on the project planning data.
Example 130 includes the subject matter of any of Examples 103-129, and wherein to produce, with an artificial intelligence model, estimation data comprises to utilize a machine learning model to produce the estimation data.
Example 131 includes the subject matter of any of Examples 103-130, and wherein to produce, with an artificial intelligence model, estimation data comprises to utilize a computer vision model to produce the estimation data.
Example 132 includes the subject matter of any of Examples 103-131, and wherein to produce, with an artificial intelligence model, estimation data comprises to utilize a deep learning model to produce the estimation data.
Example 133 includes the subject matter of any of Examples 103-132, and wherein to produce, with an artificial intelligence model, estimation data comprises utilizing a generative artificial intelligence to produce the estimation data.
Example 134 includes the subject matter of any of Examples 103-133, and wherein to produce, with an artificial intelligence model, estimation data comprises to utilize a large language model to produce the estimation data.
Example 135 includes the subject matter of any of Examples 103-134, and wherein to produce, with an artificial intelligence model, estimation data comprises to utilize a large vision model to produce the estimation data.
Example 136 includes the subject matter of any of Examples 103-135, and wherein to produce, with an artificial intelligence model, estimation data comprises to utilize a composite model of multiple artificial intelligence models to produce the estimation data.
Example 137 includes the subject matter of any of Examples 103-136, and wherein to produce, with an artificial intelligence model, estimation data comprises to perform one or more model selection operations.
Example 138 includes the subject matter of any of Examples 103-137, and wherein to perform one or more model selection operations comprises to select or weight output from multiple artificial intelligence models.
Example 139 includes the subject matter of any of Examples 103-138, and wherein to select or weight output comprises to select or weight the output based on a prediction accuracy of each artificial intelligence model compared to historical estimation data associated with historical construction projects.
Example 140 includes the subject matter of any of Examples 103-139, and wherein the instructions additionally cause the system to select or weight the output based on prediction accuracy associated with historical construction projects having features within a defined similarly threshold of features in the feature vector.
Example 141 includes the subject matter of any of Examples 103-140, and wherein to perform one or more model selection operations comprises to combine output from models trained to predict costs associated with different aspects of the total cost of a construction project.
Example 142 includes the subject matter of any of Examples 103-141, and wherein to produce, with an artificial intelligence model, estimation data comprises to determine a labor cost for the planned construction.
Example 143 includes the subject matter of any of Examples 103-142, and wherein to produce, with an artificial intelligence model, estimation data comprises to determine a material cost for the planned construction.
Example 144 includes the subject matter of any of Examples 103-143, and wherein to produce, with an artificial intelligence model, estimation data comprises to determine a transportation cost for the planned construction.
Example 145 includes the subject matter of any of Examples 103-144, and wherein the instructions additionally cause the system to produce a takeoff list indicative of materials and trusses to be utilize in the planned construction of the building.
Example 146 includes the subject matter of any of Examples 103-145, and wherein the instructions additionally cause the system to produce data indicative of key attributes determined to have the greatest influence on the estimated cost associated with the planned construction.
Example 147 includes the subject matter of any of Examples 103-146, and wherein to produce data indicative of key attributes comprises to produce data indicative of lumber spacing, square footage, or wall height.
Example 148 includes the subject matter of any of Examples 103-147, and wherein to produce estimation data comprises to produce data indicative of a rationale for the estimated cost.
Example 149 includes the subject matter of any of Examples 103-148, and wherein to produce data indicative of a rationale comprises to produce data indicative of a cost associated with a historical construction project determined to be similar to the planned construction.
Example 150 includes the subject matter of any of Examples 103-149, and wherein to produce estimation data comprises to produce data indicative of a relative complexity of the planned construction compared to one or more other construction projects.
Example 151 includes the subject matter of any of Examples 103-150, and wherein the instructions additionally cause the system to receive data indicative of acceptance or rejection of the estimation data.
Example 152 includes the subject matter of any of Examples 103-151, and wherein to receive data indicative of acceptance or rejection of the estimation data comprises to obtain data indicative of a reason for rejection of the estimation data; obtain refinement data indicative of a refinement to the estimation data; and store the refinement data for continual training of the artificial intelligence model.
Example 153 includes the subject matter of any of Examples 103-152, and wherein the instructions additionally cause the system to obtain component project planning data indicative of a planned construction of a building component; perform one or more preprocessing operations on the obtained component project planning data to prepare a feature vector of one or more features usable by an artificial intelligence model to produce a prediction; produce, with the artificial intelligence model and as a function of the obtained component project planning data and the feature vector, estimation data indicative of an estimated cost associated with construction of the building component; and present the estimation data.

1. A system comprising:
circuitry configured to:
obtain project planning data indicative of a planned construction of a building;
perform one or more preprocessing operations on the obtained project planning data to prepare a feature vector of one or more features usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data;
produce, with each determined subset of artificial intelligence models associated with each identified class and as a function of the obtained project planning data and the feature vector, estimation data indicative of an estimated cost associated with construction of the building; and
present the estimation data.

2. The system of claim 1, wherein the circuitry is further configured to initiate, with one or more manufacturing devices, production of one or more components of the building in response to a determination that the estimation data satisfies corresponding criteria.

3. The system of claim 1, wherein the circuitry is further configured to define a set of rules to be provided to one or more artificial intelligence models of a corresponding subset to restrict an analysis of the one or more artificial intelligence models and to increase an accuracy of an inference produced by the one or more artificial intelligence models.

4. The system of claim 1, wherein one or more items of the obtained project planning data is representative of a page of a corresponding document and wherein to perform classification operations comprises to determine a class of at least one item with one or more of optical character recognition or natural language processing.

5. The system of claim 1, wherein the circuitry is further configured to:
determine, as a function of the classes, a relative importance of each item of obtained project data; and
resolve one or more conflicts among items of the obtained project data as a function of the determined relative importance of each item of obtained project data.

6. The system of claim 1, wherein the circuitry is further configured to:
determine, as a function of the classes, a relative importance of each item of obtained project data; and
limit an amount of the items of the obtained project planning data to be provided to the set of artificial intelligence models as a function of the determined relative importance of each item of the obtained project data to increase a computational efficiency in the production of an inference, by the set of artificial intelligence models, indicative of the estimation data.

7. The system of claim 1, wherein the circuitry is further configured to:
cause one or more of the artificial intelligence models to perform chain of thought reasoning to produce at least a portion of the estimation data, to reduce a likelihood of hallucination by the one or more artificial intelligence models; and
present a representation of the chain of thought reasoning with the estimation data.

8. The system of claim 1, wherein to produce, with an artificial intelligence model, estimation data comprises to perform one or more model selection operations including selecting or weighting output from multiple artificial intelligence models based on a prediction accuracy of each artificial intelligence model compared to historical estimation data associated with historical construction projects having features within a defined similarly threshold of features in the feature vector.

9. The system of claim 8, wherein to perform one or more model selection operations comprises to combine output from models trained to predict costs associated with different aspects of the total cost of a construction project.

10. The system of claim 1, wherein to obtain project planning data comprises to obtain architecture drawing data indicative of one or more architectural drawings of the building including one or more of a floor plan or a roof elevation plan.

11. The system of claim 1, wherein to obtain project planning data comprises to obtain data indicative of a geographic location for the building, a geographic location of a component manufacturer for at least one component of the building, a delivery date for one or more construction components, a target completion date for the building, and equipment to be utilized in the construction.

12. The system of claim 1, wherein to obtain project planning data comprises to:
determine whether the obtained data satisfies a data completeness threshold; and
request, in response to a determination that the obtained data does not satisfy the data completeness threshold, additional project planning data.

13. The system of claim 1, wherein the circuitry is further configured to:
obtain data indicative of a reason for rejection of the estimation data;
obtain refinement data indicative of a refinement to the estimation data; and
store the refinement data for continual training of an artificial intelligence model in the set.

14. The system of claim 1, wherein the circuitry is further configured to:
obtain component project planning data indicative of a planned construction of a building component;
perform one or more preprocessing operations on the obtained component project planning data to prepare a second feature vector of one or more features usable by an artificial intelligence model to produce a prediction;
produce, with the artificial intelligence model and as a function of the obtained component project planning data and the second feature vector, estimation data indicative of an estimated cost associated with construction of the building component; and
present the estimation data indicative of the estimated cost associated with construction of the building component.

15. A method comprising:
obtaining, by a compute device, project planning data indicative of a planned construction of a building;
performing, by the compute device, one or more preprocessing operations on the obtained project planning data to prepare a feature vector of one or more features usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data;
producing, by the compute device, with each determined subset of artificial intelligence models associated with each identified class and as a function of the obtained project planning data and the feature vector, estimation data indicative of an estimated cost associated with construction of the building; and
present the estimation data.

16. The method of claim 15, further comprising initiating, by the compute device, with one or more manufacturing devices, production of one or more components of the building in response to a determination that the estimation data satisfies corresponding criteria.

17. The method of claim 15, further comprising defining, by the compute device, a set of rules to be provided to one or more artificial intelligence models of a corresponding subset to restrict an analysis of the one or more artificial intelligence models and to increase an accuracy of an inference produced by the one or more artificial intelligence models.

18. The method of claim 15, wherein one or more items of the obtained project planning data is representative of a page of a corresponding document and wherein performing classification operations comprises determining a class of at least one item with one or more of optical character recognition or natural language processing.

19. The method of claim 15, further comprising:
determining, by the compute device and as a function of the classes, a relative importance of each item of obtained project data; and
resolving, by the compute device, one or more conflicts among items of the obtained project data as a function of the determined relative importance of each item of obtained project data.

20. One or more machine-readable storage media comprising a plurality of instructions stored thereon that, in response to being executed, cause a system to:
obtain project planning data indicative of a planned construction of a building;
perform one or more preprocessing operations on the obtained project planning data to prepare a feature vector of one or more features usable by a set of artificial intelligence models to produce a prediction, including performing classification operations to identify classes of items of the obtained project planning data to determine, as a function of each identified class, a corresponding subset of the set of artificial intelligence models to operate on each corresponding item of obtained project planning data;
produce, with each determined subset of artificial intelligence models associated with each identified class and as a function of the obtained project planning data and the feature vector, estimation data indicative of an estimated cost associated with construction of the building; and
present the estimation data.
